(19) United States
(12) Patent Application Publication
(10) Pub. No.: US 2010/0232561 A1
(43) Pub. Date: Sep. 16, 2010

(54) Nuclear power generation method and system

(76) Inventor: Michael Joseph Boss, Balston Spa, NY (US)

Correspondence Address: CANTOR COLBURN, LLP, 20 Church Street, 22nd Floor, Hartford, CT, 06103, US

(21) Appl. No.: 11/651,252

(22) Filed: Jan. 9, 2007

(51) Int. Cl. G21C 7/00

(52) U.S. Cl. 376/241

(57) ABSTRACT

A power generation system is disclosed. The power generation system includes a nuclear reactor, a steam turbine, a gas turbine, and a primary generator. The steam turbine is in thermal connection with the nuclear reactor via a transfer medium and converts thermal energy to rotation. The gas turbine converts thermal energy to rotation and is in thermal connection with the transfer medium to increase a thermal energy of the transfer medium. The primary generator is in mechanical connection with the steam turbine to generate power in response to a rotation of a rotor of the primary generator.

### BACKGROUND OF THE INVENTION

The present disclosure relates generally to power generation, and particularly to nuclear power generation.

Current designs of nuclear-based power generation plants include at least boiling water reactors (BWR) and pressurized water reactors (PWR). A BWR nuclear steam turbine uses steam that is directly generated by the nuclear reactor. A PWR nuclear steam turbine includes a closed primary loop within the nuclear reactor to provide thermal energy to provide steam in a secondary loop of a steam generator. The steam is then provided to the turbine via the secondary loop. Current nuclear reactor generator systems are operated at full steam generation capacity, also known as full Megawatt thermal for the life of the fuel bundles. Accordingly, the generator systems are unable to respond to peak electrical demands, which may be accommodated via additional generation systems located elsewhere, the additional generation systems each having their own facility and corresponding operation overhead costs.

Additionally, the fuel rods of the nuclear reactor need to be cooled with a high heat transfer coefficient medium, that is they require a rapid transfer of heat. In the liquid phase, the heat transfer coefficient of water is suitable for this purpose, however, in the gaseous phase, known as steam, the heat transfer coefficient of water is not sufficient for adequate cooling. Therefore the nuclear reactor fuel rods must be immersed in water. As the cooling takes place, the water near the rods will boil, and rise to the surface of the reactor vessel. This boiled water is saturated steam, and its thermal energy is sent directly (for the BWR) or via the steam generator (for the PWR) to the steam turbine to expand and produce work.

Typically, the BWR provides saturated steam to the turbine and PWR provides steam that is superheated with approximately 35 degrees Fahrenheit (F) of superheat. When steam expands in the turbine, the pressure is reduced by this expansion, and the enthalpy of the steam is reduced as the steam does work on the turbine rotor. When the steam is saturated, or only slightly superheated, this expansion process increases the moisture content of the expanded steam as it passes through the turbine. The moisture in the steam will result in erosion of turbine components and cause a loss in the expansion of the steam through the turbine. The loss will result in poor steam turbine efficiency. Current nuclear power generation systems utilize moisture separators to remove reduce the moisture content within the steam. The moisture separators are expensive pieces of equipment that consume significant space within the power generation facility.

Accordingly, there is a need in the art for a nuclear power generation arrangement that overcomes these limitations.

### BRIEF DESCRIPTION OF THE INVENTION

An embodiment of the invention includes a power generation system. The power generation system includes a nuclear reactor, a steam turbine, a gas turbine, and a primary generator. The steam turbine is in thermal connection with the nuclear reactor via a transfer medium and converts thermal energy to rotation. The gas turbine converts thermal energy to rotation and is in thermal connection with the transfer medium to increase a thermal energy of the transfer medium. The primary generator is in mechanical connection with the steam turbine to generate power in response to a rotation of a rotor of the primary generator.

Another embodiment of the invention includes a method of generating electrical energy. The method includes transporting thermal energy from a nuclear reactor to a steam turbine via a transfer medium, generating thermal energy and rotation of a shaft of a gas turbine, combining a portion of the thermal energy generated by the gas turbine with the thermal energy of the transfer medium, converting the combined thermal energy of the transfer medium to rotation of a shaft of the steam turbine, and converting the rotation of the shaft of the steam turbine to electrical energy via a primary generator.

These and other advantages and features will be more readily understood from the following detailed description of preferred embodiments of the invention that is provided in connection with the accompanying drawings.

### BRIEF DESCRIPTION OF THE DRAWINGS

FIG. 1 depicts a schematic diagram of a combined nuclear power generation (CNPG) system in accordance with an embodiment of the invention; and

FIG. 2 depicts a flowchart of process steps for generating electrical power by a CNPG system in accordance with an embodiment of the invention.

### DETAILED DESCRIPTION OF THE INVENTION

An embodiment of the invention provides a series of gas turbines, exhausting into heat recovery steam generators (HRSG's), which add thermal energy to the steam coming from one of the nuclear reactor and the steam generator that includes the nuclear reactor as part of the primary loop. The added thermal energy will result in a temperature of the steam that is superheated to approximately 300 to 700 degrees F. of superheat. At this level of superheat, the steam will have very little moisture loss in response to the steam turbine expansion. An embodiment will incorporate redundancy of the gas turbines to account for the shorter gas turbine maintenance cycle. An embodiment will allow for the removal of the moisture separator, and the corresponding capital, maintenance and floor space costs.

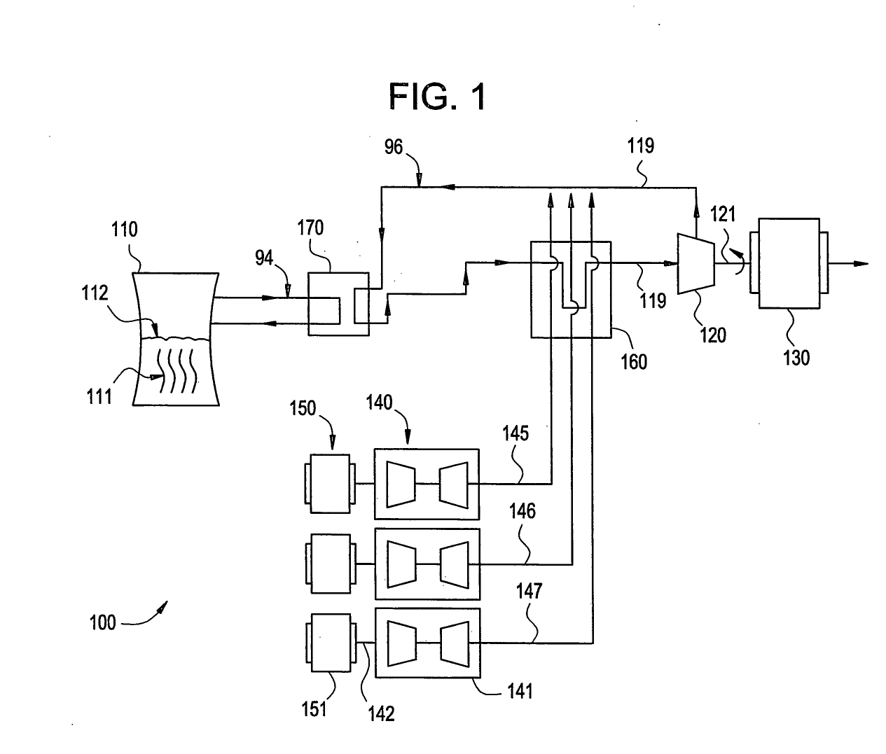

Referring now to FIG. 1, an embodiment of a combined nuclear power generation CNPG system 100 is depicted. The CNPG system 100 includes a nuclear reactor 110, a steam turbine 120, a primary generator 130, and a plurality of gas turbines 140. An embodiment of the CNPG system further includes a plurality of secondary generators 150.

The nuclear reactor 110 includes a plurality of fuel rods 111 that are surrounded by a cooling medium 112, such as water. The cooling medium 112 cools the fuel rods 111. Thermal energy generated by the plurality of fuel rods 111 is absorbed by the cooling medium 112 and transferred to the steam turbine 120. The thermal energy generated by the fuel rods 111 is transferred by a transfer medium, such as steam, to the steam turbine via steam pipes 119. The steam turbine 120 converts the thermal energy to mechanical energy, which causes a shaft 121 of the steam turbine 120 to rotate. The shaft 121 of the steam turbine is in mechanical connection with a rotor of the primary generator 130. The primary generator 130 will convert the mechanical energy of the rotation of the rotor to electrical energy, also herein referred to as power, which will be distributed to electrical consumers. As used herein, the term “electrical consumers” refers to any person, group, business, entity, or device that may utilize electrical power.

In a similar fashion, each gas turbine 141 will convert thermal energy resulting from combustion of fuel, such as jet fuel, kerosene, and natural gas, for example, to a rotation of a shaft 142 of the gas turbine 141. As used herein reference numeral 141 will refer generally to any one of the plurality of gas turbines 140. The shaft 142 of the gas turbine 141 is in mechanical connection with a rotor of the secondary generator 151. The secondary generator 151 will convert the mechanical energy of the rotation of the rotor to electrical energy, which will be distributed to electrical consumers. It will be appreciated that in response to the combustion of fuel, exhaust gasses will be produced by the plurality of gas turbines 140. Manifolds 145, 146, 147 transport the exhaust gasses to a HRSG 160 that will transfer thermal energy from the exhaust gasses to the transfer medium as will be described further below. Subsequent to transport to the HRSG 160, the exhaust gasses may be appropriately vented to the atmosphere.

While an embodiment has been depicted having three gas turbines 140 including manifolds 145, 146, 147 that are in thermal connection with one HRSG 160, it will be appreciated that the scope of the embodiment is not so limited, and that the embodiment will also apply to CNPG systems 100 that have other numbers of gas turbines 140, such as two, four, five, six, or more, for example, and that may utilize other arrangements of HRSG's 160, such as to have multiple HRSG's 160, including one or more manifold within each HRSG 160, for example.

In an embodiment, the nuclear reactor 110 of the CNPG system 100 is the PWR and further includes a steam generator 170. The steam generator 170 is in thermal connection with the cooling medium 112 and the transfer medium, and acts as an interface to transfer thermal energy between a primary loop 94 and a secondary loop 96. The steam generator 170 transfers the thermal energy absorbed from the fuel rods 111 by the cooling medium 112 within the primary loop 94 to the transfer medium within the secondary loop 96. In an embodiment, the cooling medium 112 is saturated steam, and the transfer medium is superheated steam, with about 35 degrees F. of superheat. As used herein with regard to an amount of superheat, the term “about” will include a deviation from the stated value of superheat that results from design, manufacturing, and operating tolerances.

In another embodiment, the nuclear reactor 110 of the CNPG system 100 is the BWR, absent the steam generator 170. Accordingly, the cooling medium 112 is the transfer medium, and transfers the thermal energy absorbed from the fuel rods 111 to the steam turbine 120. Therefore, the cooling medium 112 is transported from the nuclear reactor 110 to the steam turbine 120 via the steam pipes 119. It will therefore be appreciated that because the cooling medium 112 is the transfer medium, a thermal energy state of the transfer medium is saturated steam.

In an embodiment, the HRSG 160 transfers thermal energy from the exhaust gasses of the gas turbines 140 to the transfer medium. As a result of the transfer of thermal energy from the exhaust gasses of the gas turbines 140 to the transfer medium, the thermal energy of the transfer medium is increased significantly, to the thermal energy state of about 300 to 700 degrees F. of superheat.

As a result of the increase of the thermal energy of the transfer medium to the thermal energy state of about 300 to 700 degrees of superheat, an amount of moisture present in the transfer medium will be significantly reduced when compared to the transfer medium having the thermal energy of one of saturated steam and about 35 degrees F. of superheat. The reduction of moisture in the transfer medium will significantly reduce the loss in the expansion of the transfer medium as it passes through the steam turbine 120. It is contemplated that embodiments of the CNPG system 100 will have thermal cycle efficiencies of about 37 to 38 percent, as compared to current nuclear power generation system thermal cycle efficiencies of about 30 to 33 percent.

Furthermore, the reduction of moisture in the transfer medium is contemplated to extend an operational life of the steam turbine 120 components. Moisture within the transfer medium contributes to erosion of the steam turbine 120 components. Current nuclear power generation systems include large moisture separators to remove moisture from the transfer medium. These moisture separators often cost millions of dollars, and require considerable amounts of floor space. Use of the HRSG 160 to increase the thermal energy of the transfer medium is expected to eliminate the need for the moisture separator, reduce the moisture content of the transfer medium, and extend the operational life of the steam turbine components.

Current nuclear reactors are often required to be sized large enough such that the total power output is large enough to offset the capital costs associated with their construction. An example of a current nuclear reactor is a nuclear reactor having a thermal output of approximately 4000 Megawatts thermal (MWth). The expected total power output, large enough to offset the associated capital costs, of the current nuclear reactor having the thermal output of approximately 4000 MWth, is approximately 1000 Megawatts electrical (MWe). As used herein, the term “approximately” shall refer to a design target that may vary as a result of parameter optimization, including parameters such as operating conditions, component sizes, component efficiencies, and power demands, for example.

It will be appreciated that the amount of thermal energy required to provide about 300 to 700 degrees F. of superheat to the transfer medium will be directly related to a flow rate of the transfer medium, which corresponds to the size of the nuclear reactor 110. The amount of thermal energy available to be added to the transfer medium by the HRSG 160 is directly related to the number of gas turbines 140 included within the CNPG system 100. Therefore, it is contemplated that incorporation of nuclear reactors 110, as currently sized, into CNPG systems 100 systems will require approximately seven standard gas turbines 141 to generate the thermal energy necessary to provide the thermal energy state of the transfer medium of about 300 to 700 degrees F. of superheat.

Inclusion of the secondary generators 150 with the corresponding gas turbines 140 will increase the power generating capacity of the CNPG system 100. It is contemplated that the increased power generating capacity of the secondary generators 150 will allow for incorporation of a smaller nuclear reactor 110 into the CNPG system 100 of a given power generating capacity. Incorporation of the smaller nuclear reactor 110 will reduce the flow rate of the transfer medium, and thereby reduce the thermal energy needed to provide the thermal energy state of the transfer medium of about 300 to 700 degrees F. of superheat. Accordingly, the number of gas turbines 140 required will be likewise reduced. In an embodiment, the CNPG system 100 is contemplated to be a CNPG system having a power generating capacity of at least 1000 MWe, with the nuclear reactor 110 contemplated to have a thermal output of at least 1500 MWth, and an electrical output of at least 500 MWe. In another embodiment, the CNPG system 1000 is contemplated to be a CNPG system having a power generating capacity of approximately 1270 MWe, with the nuclear reactor 110 contemplated to have a thermal output of approximately 1700 MWth, and an electrical output of approximately 600 MWe. Further, in an embodiment the CNPG system 100 is contemplated to include at least 4 gas turbines 141 to generate the thermal energy necessary to provide the thermal energy state of the transfer medium of about 300 to 700 degrees F. of superheat, and the additional approximate 600 MWe of electrical output. In an exemplary embodiment, the CNPG system will include 5 gas turbines 141. In another embodiment, the CNPG system will include fewer or more gas turbines 141, such as 2, 3, 6, 7, or more gas turbines 141 for example.

While an embodiment has been described having the nuclear reactor 110 contemplated to have the output of approximately 1700 MWth and 600 MWe, it will be appreciated that the scope of the embodiment is not so limited, and that the embodiment will also apply to CNPG systems 100 that will include nuclear reactors 110 with other energy outputs, such as from 1000 to 2500 MWth and 300 to 900 MWe. Further, while an embodiment has been described as having a total system output of approximately 1270 MWe, it will be appreciated that that the scope of the embodiment is not so limited, and that the embodiment will also apply to CNPG systems that have a total power output from about 750 to 2000 MWe.

Current nuclear reactors 110 are operated at full Megawatt thermal condition for the life of the fuel rods 111, which is commonly 18 to 24 months. Standard gas turbines 120 commonly include shorter duration service intervals, such as every 10,000 hours, or 12 months. Therefore, it is contemplated that an exemplary embodiment of the CNPG system 100 will include a number of gas turbines 140 that is greater than a number of gas turbines 140 required to provide the thermal energy necessary to provide a desired thermal energy state of the transfer medium. The difference between the number of gas turbines 140 included within the CNPG system 100 and the number of gas turbines 140 necessary to provide the desired thermal energy state of the transfer medium will provide a redundancy to ensure that there is sufficient thermal energy available to provide the desired thermal energy state of the transfer medium corresponding to full Megawatt operation, in response to the need to shut down the gas turbine 141 for service. In an embodiment, the redundancy will allow the nuclear reactor 110 to continue to operate at full Megawatt thermal condition including the thermal energy state of the transfer medium of about 300 to 700 degrees F. of superheat during a service of at least one gas turbine 141.

Because current nuclear power generating systems operate at full Megawatt thermal condition, they are unable to increase their power output in response to any peak demands for power. In response to peak demands for power, power generation operators must start and stop additional power generation equipment located at other facilities. It will be appreciated that each facility will have associated overhead costs, and that a reduction in the number of facilities required to meet power demands can reduce overall costs. In an embodiment, the CNPG system 100 can respond to peak power demands by using the gas turbines 140 that are redundant, or in excess of the gas turbines 140 necessary to increase the thermal energy of the transfer medium to the desired thermal energy state, such as about 300 to 700 degrees F. of superheat, for example.

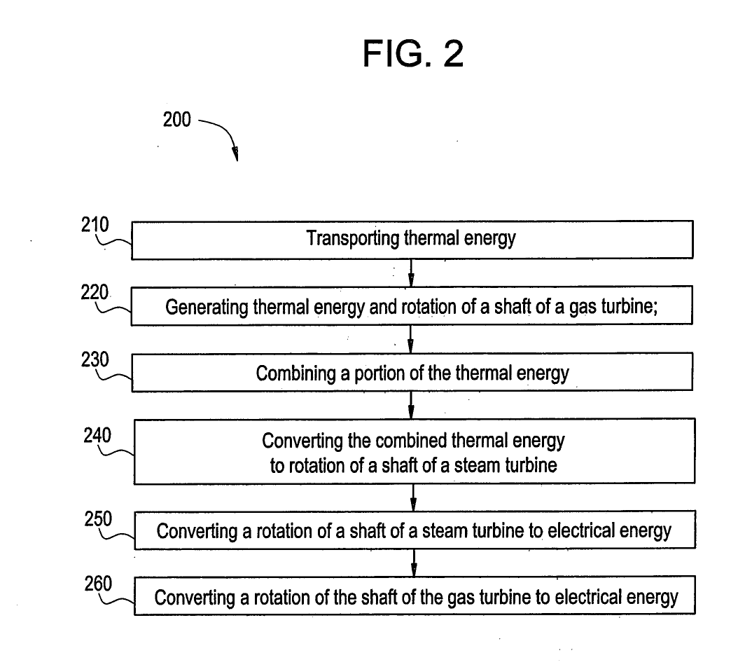

Referring now to FIG. 2, a flowchart 200 of process steps for generating electrical power by a CNPG system, such as the CNPG system 100, is depicted.

The process begins with transporting at Step 210 thermal energy from the nuclear reactor 110 to the steam turbine 120 via the transfer medium, generating at Step 220, in response to the combustion of fuel, thermal energy and rotation of the shaft 142 of the gas turbine 141, combining at Step 230 a portion of the thermal energy generated by the gas turbine 141 with the thermal energy of the transfer medium, converting at Step 240 the combined thermal energy of the transfer medium to rotation of the shaft 121 of the steam turbine 120. The process further includes converting at Step 250 the rotation of the shaft 121 of the steam turbine 120 to electrical energy via the primary generator 130. An embodiment includes converting at Step 260 the rotation of the shaft 142 of the gas turbine 141 to electrical energy via the secondary generator 151.

In an embodiment, the combining at Step 230 includes transferring thermal energy from the gas turbine 141 to the transfer medium via the HRSG 160. In an embodiment, the converting at Step 240 the combined thermal energy includes converting the combined thermal energy of the transfer medium having the thermal energy state of about 300 to 700 degrees Fahrenheit of superheat to rotation of the shaft 121 of the steam turbine 120. In an embodiment, the generating at Step 220 thermal energy comprises generating thermal energy and rotation of the plurality of shafts 142 of the plurality of gas turbines 140, the number of the plurality of gas turbines 140 greater than the number of gas turbines 141 necessary to provide the combined thermal energy of the transfer medium having the thermal energy state of about 300 to 700 degrees Fahrenheit of superheat.

In an embodiment, the transporting at Step 210 includes transporting thermal energy from the nuclear reactor 110 to the steam turbine 120 via steam. In an embodiment, the transporting at Step 210 includes transferring thermal energy from the nuclear reactor 110 to the cooling medium 112 and transferring thermal energy from the cooling medium 112 to the transfer medium via the steam generator 160.

In an embodiment the converting, at Steps 250 and 260, rotation of the shaft 121 of the steam turbine 120 to electrical energy and rotation of the shaft 142 of the gas turbine 141 to electrical energy include converting the rotation of the shaft 121 of the steam turbine 120 and the shaft 142 of the gas turbine 141 to generate the total average system capacity of 1270 MWe of electrical power. In an embodiment, the transporting at Step 210 thermal energy includes transporting thermal energy from the nuclear reactor 110 having the thermal output of approximately 1700 MWth via the transfer medium to the steam turbine 120. In an embodiment, the generating at Step 220 thermal energy includes generating thermal energy and rotation of 4 shafts 142 of 4 gas turbines 140.

As disclosed, some embodiments of the invention may include some of the following advantages: the ability to increase thermal cycle efficiency; the ability to accommodate peaks in power demand; the ability to reduce required nuclear reactor size for a given system output; the ability to increase steam turbine component life; and the ability to reduce a total number of power generation facilities.

While the invention has been described with reference to exemplary embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best or only mode contemplated for carrying out this invention, but that the invention will include all embodiments falling within the scope of the appended claims. Also, in the drawings and the description, there have been disclosed exemplary embodiments of the invention and, although specific terms may have been employed, they are unless otherwise stated used in a generic and descriptive sense only and not for purposes of limitation, the scope of the invention therefore not being so limited. Moreover, the use of the terms first, second, etc. do not denote any order or importance, but rather the terms first, second, etc. are used to distinguish one element from another. Furthermore, the use of the terms a, an, etc. do not denote a limitation of quantity, but rather denote the presence of at least one of the referenced item.

1. A power generation system comprising:
a transfer medium;
a nuclear reactor thermally connected to the transfer medium and capable of increasing a thermal energy of the transfer medium;
a steam turbine thermally connected to the transfer medium and capable of converting the thermal energy of the transfer medium to rotation;
a gas turbine arranged in parallel with the nuclear reactor and in thermal connection with the transfer medium and capable of increasing the thermal energy of the transfer medium entering the steam turbine via an exhaust gas of the gas turbine, the gas turbine driven by a fuel independent of the nuclear reactor; and
a primary generator in mechanical connection with the steam turbine to generate power in response to a rotation of a rotor of the primary generator.

2. The system of claim 1, further comprising:
a secondary generator in mechanical connection with the gas turbine to generate power in response to a rotation of a rotor of the secondary generator.

3. The system of claim 1, further comprising:
a heat recovery steam generator (HRSG) to transfer thermal energy from an exhaust of the gas turbine to the transfer medium.

4. The system of claim 1, wherein:
the transfer medium entering the steam turbine comprises thermal energy of about 300 to 700 degrees Fahrenheit of superheat.

5. The system of claim 4, wherein the gas turbine comprises a plurality of gas turbines, wherein:
a number of the plurality of gas turbines is greater than a number of gas turbines necessary to increase the thermal energy of the transfer medium entering the steam turbine to about 300 to 700 degrees Fahrenheit of superheat.

6. The system of claim 1, wherein:
the transfer medium is steam.

7. The system of claim 1, further comprising:
a cooling medium to cool the nuclear reactor; and
a steam generator in thermal connection with the cooling medium and the transfer medium, the steam generator transferring thermal energy from the cooling medium to the transfer medium.

8. The system of claim 1, wherein:
the power generation system generates at least 1000 Megawatts electrical (MWe).

9. The system of claim 8, wherein:
the nuclear reactor generates at least 1500 Megawatts thermal (MWth).

10. The system of claim 9, comprising:
at least two gas turbines arranged to operate in parallel.

11. A method of generating electrical energy comprising:
transporting thermal energy from a nuclear reactor to a steam turbine via a transfer medium;
generating thermal energy and rotation of a shaft of a gas turbine;
combining a portion of the thermal energy generated by the gas turbine with the thermal energy of the transfer medium;
converting the combined thermal energy of the transfer medium to rotation of a shaft of the steam turbine; and
converting the rotation of the shaft of the steam turbine to electrical energy via a primary generator.

12. The method of claim 11, further comprising:
converting the rotation of the shaft of the gas turbine to electrical energy via a secondary generator.

13. The method of claim 12, wherein the converting the rotation of the shaft of the steam turbine to electrical energy and the converting the rotation of the shaft of the gas turbine to electrical energy comprise:
converting the rotation of the shaft of the steam turbine and the shaft of the gas turbine to generate a total of at least 1000 Megawatts electrical (MWe).

14. The method of claim 13, wherein the transporting thermal energy comprises:
transporting thermal energy from the nuclear reactor having a thermal output of at least 1500 Megawatts thermal (MWth) via the transfer medium to the steam turbine.

15. The method of claim 14, wherein the generating thermal energy comprises:
rotation of at least two shafts of at least two gas turbines.

16. The method of claim 11, wherein the combining comprises:
transferring thermal energy from the gas turbine to the transfer medium via a heat recovery steam generator (HRSG).

17. The method of claim 11, wherein the converting the combined thermal energy comprises:
converting the combined thermal energy of about 300 to 700 degrees Fahrenheit of superheat to rotation of the shaft of the steam turbine.

18. The method of claim 17, wherein:
the generating thermal energy comprises generating thermal energy and rotation of a plurality of shafts of a plurality of gas turbines, a number of the plurality of gas turbines greater than a number of gas turbines necessary to provide the combined thermal energy of the transfer medium having the thermal energy of about 300 to 700 degrees Fahrenheit of superheat.

19. The method of claim 11, wherein the transporting thermal energy comprises:
transporting thermal energy from the nuclear reactor to the steam turbine via steam.

20. The method of claim 11, wherein the transporting thermal energy comprises:
transferring thermal energy from the nuclear reactor to a cooling medium; and
transferring thermal energy from the cooling medium to the transfer medium via a steam generator.
